(19) United States
(12) Patent Application Publication
(10) Pub. No.: US 2003/0013506 A1
(43) Pub. Date: Jan. 16, 2003

(54) Stand-by battery assembly for portable electronic products

(76) Inventor: Wen-Hsu Wang, Taipei (TW)

Correspondence Address: Wen-Hsu Wang, PO Box 82-144, Taipei, TW

(21) Appl. No.: 09/774,578

(22) Filed: Feb. 1, 2001

(51) Int. Cl. H04M 1/00

(52) U.S. Cl. 455/573; 455/571; 455/572; 455/574; 455/550

(57) ABSTRACT

The standby battery assembly for use on the portable electronic products is attached to their back or an adequate place. The battery assembly has a casing for housing a plurality of batteries ( two batteries or more). The batteries are exchangeable within the casing, with a selection switch to shift between two batteries, or two batteries are arranged in the 180° direction, reversed direction or same direction to couple with the flexible operation of the portable electronic products.

### BACKGROUND OF INVENTION

The so-called portable electronic products are implying the cell phone set, the radio walkie-talkie, the notebook PC, PDA and the re-charger base board which is outfitted with a main battery on their back or at the appropriate place. The major shortcoming the main battery inheres is that when the end-users are out of the house or of the car, if the main battery runs out the power, there is no way to find a similar model of the standby battery for replacement. This dilemma therefore renders the portable electronic product useless and the communication disrupted, and brings forth the greatest impairment and inconvenience to the end-users.

Even though some end-users are considering the purchase of a spare battery in the same model. However, in the majority of the cases, they are often too busy to bring it with them when going out. When the main battery is out of power, the stand-by is found not available, the regret is still there for the disruption of communication and out of power. The dilemma remains forever.

### SUMMARY OF THE INVENTION

A stand-by battery assembly for the portable electronic products is especially designed to outfit on the back of the portable electronic products or at an appropriate place which is characterized on that the stand-by battery assembly has a casing which houses a plurality of batteries. One of which acts as the main battery. When the main battery is exhausted, the other battery will take the place from time to time to maintain the uninterrupted operation of the portable electronic products and to give a buffer time for the end-user to recharge the main battery. The stand-by battery assembly is usually attached to the portable electronic products, easy for the end-user to replace the exhausted main battery.

### BRIEF DESCRIPTION OF DRAWINGS

FIG. 1 shows the stereo disassembly of the battery assembly of the invention and the cell phone set.

FIG. 2 shows the stereo assembly of the battery assembly of the invention and the cell phone set.

FIG. 3 shows the stereo disassembly of the battery assembly of the invention and the cell phone set.

FIG. 4 shows the stereo disassembly of the battery assembly of the invention and the cell phone set.

FIG. 5 is a schematic diagram showing the stereo assembly of the battery assembly of the invention and the cell phone set.

FIG. 6 shows the circuit diagrams for the FIGS. 4 and 5.

FIG. 7 shows another preferable embodiment of the battery assembly of the invention,

FIG. 8 shows the stereo disassembly of the battery assembly of the invention and the cell phone set as shown in the FIG. 7.

FIG. 9 shows the stereo assembly of the battery assembly of the invention and the cell phone set as shown in the FIG. 7.

FIG. 10 shows another preferable stereo embodiment of the battery assembly of the invention.

FIG. 11 shows another preferable stereo embodiment of the battery assembly of the invention.

FIG. 12 shows another preferable stereo embodiment of the battery assembly of the invention.

FIG. 13 shows another preferable stereo embodiment of the battery assembly of the invention.

FIG. 14 shows another stereo assembly of the battery assembly of the invention mounted on the cell phone set.

FIG. 15 shows the stereo assembly of the battery assembly of the invention outfitted on the radio walkie-talkie.

FIG. 16 shows stereo assembly of the battery assembly of the invention mounted on the notebook PC.

FIG. 17 shows stereo assembly of the battery assembly of the invention mounted on the PDA.

FIG. 18 shows stereo assembly of the battery assembly of the invention mounted on the charger set.

### DETAILED DESCRIPTION OF THE INVENTION

The stand-by battery assembly of the invention is applicable to a variety of portable electronic products, namely: the cell phone set, the radio walkie-talkie, the notebook PC and PDA. For simplicity, the cell phone set is employed as the major sample for explanation.

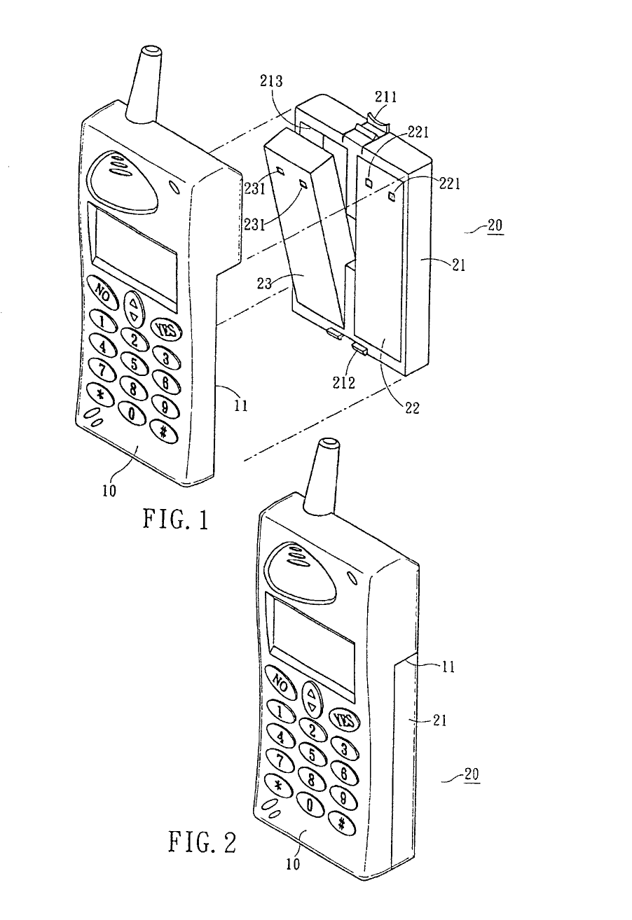

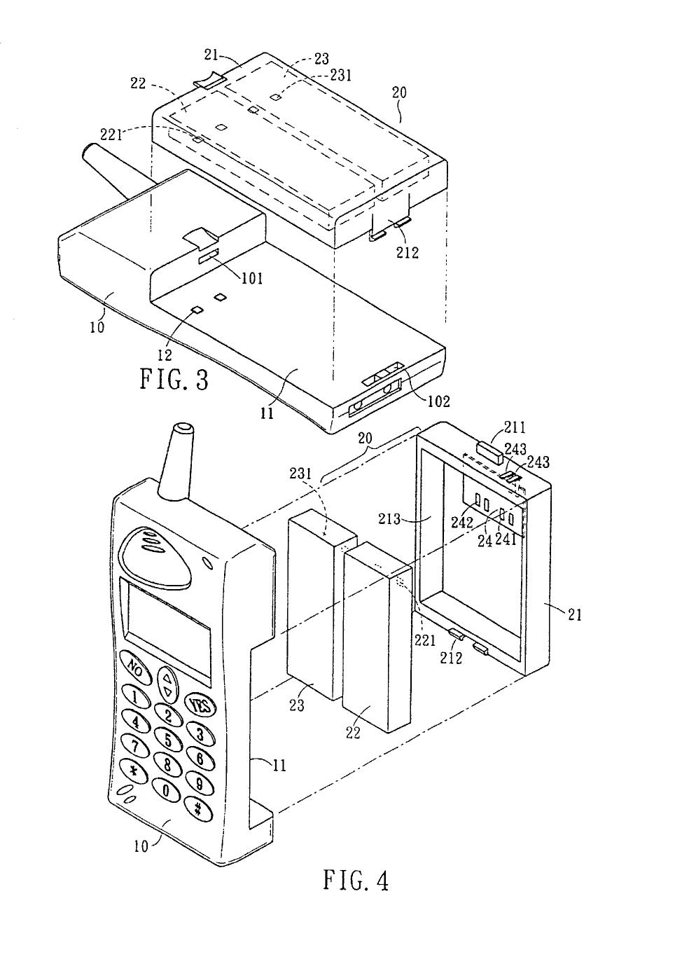

FIG. 1 shows the stereo disassembly of the battery assembly of the invention and the cell phone set, where it consists of a cell phone set 10 and a stand-by battery assembly 20 attached to the back of the cell phone set. On the back of the cell phone set, there provides a recess 11 with sufficient space to receive the stand-up battery assembly 20 which comprises a casing 21 and two batteries 22, 23 housed in the casing 21. There is an upper fastening buckle 211 and a lower fastening buckle 212 on the casing 21. The casing 21 has two slots 213 for accommodating the strong batteries 22 and 23. Each battery is provided with two metal contacts 221 and 231 for supplying power to the cell phone set 10. When the cell phone set 10 and the stand-by battery assembly 20 are combined together, they are looked as shown in the FIG. 2.

FIG. 2 shows the stereo assembly of the battery assembly of the invention and the cell phone set. Where the recess 11 of the cell phone set furnishes two conductive contacts 12. When the upper fastening buckles 211 and the lower fastening buckle 212 on the casing 20 are forced to insert into the upper notch 101 and the lower notch 102 on the cell phone set 10, so the cell phone set 10 and the stand-by battery assembly 20 are integrated, the two conductive contacts 12 will make an intimate contact to the contacts 221 on the battery 22. When the power of the battery 22 is worn out, the battery 23 will take the place of the battery 22 for continued operation of the cell phone set 10. After the battery 2 is retired from operation, it shall be recharged at an adequate time by the end-user to make it ready for replacing the battery 23 when it runs out of power.

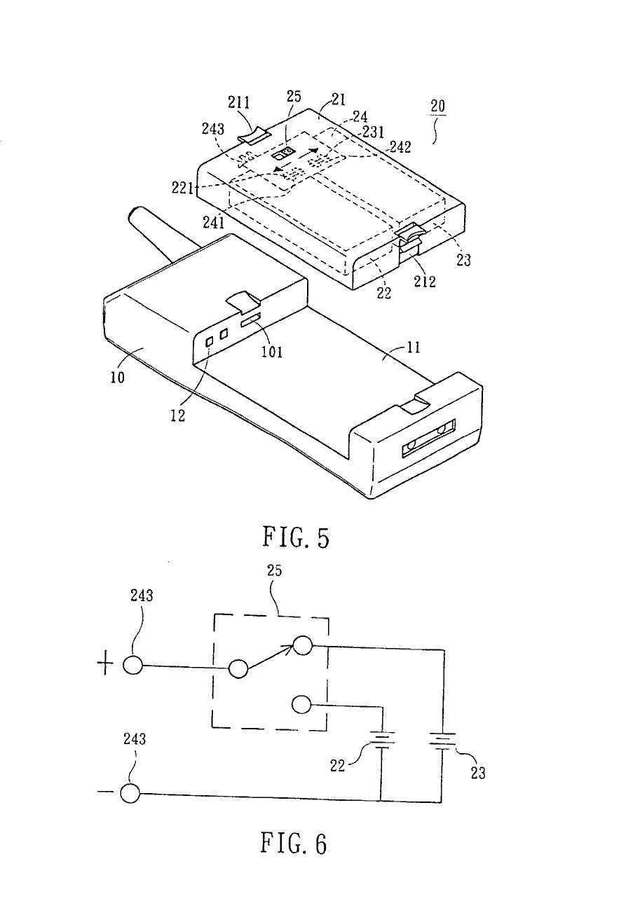

FIG. 4 is another preferable embodiment of assembled standby battery assembly and the cell phone set where the battery assembly 20 differs from the above structure. A circuit board 24 is fixed on the casing 21 with two set of four metal strips 241, 242, contacting with the metal connectors 221 and 231 of each battery respectively. Two metal strips extend outside the casing top to link with the contact 12 (see FIG.5) of the cell phone set 10. From the FIG. 5, there provides a selection switch 25 mounted on the back of the casing 21 which determines which battery will be put into operation. In case that the battery 22 runs out of power, it is convenient for the selection switch 25 to shifts to the battery 23 for power supply.

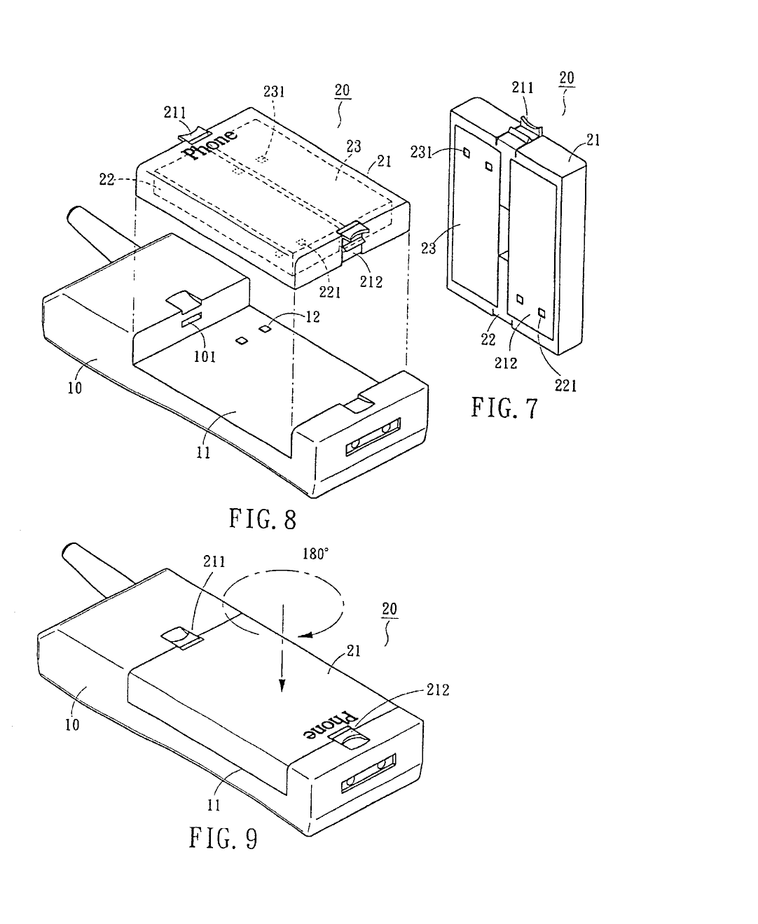

FIG. 7 shows another embodiment of the standby battery assembly 20, comprising two batteries 22 and 23 arranged in reversed position in which the metal contacts 221 and 231 are arranged differently. Taking battery 22 as an example, two metal contacts 221 are placed at the lower end of the batter 22, and two metal contacts 231 are placed at the top end of the battery 23. The casing 21 has the upper and lower fastening buckles 211 and 212, correspondingly, the cell phones set has the upper and lower fastening slots 101 and 102, holding the two buckles 211 and 212 perfectly. In FIG. 8, the two metal strips 231 of the battery 23 in the battery assembly are connected to the conductive contact 12 of the cell phone set 10. After the battery 23 is exhausted, taking off the battery assembly, turning it 180° and installing it back to the cell phone set 10, now the battery 22 is now supplying the power to the cell phone set 10.

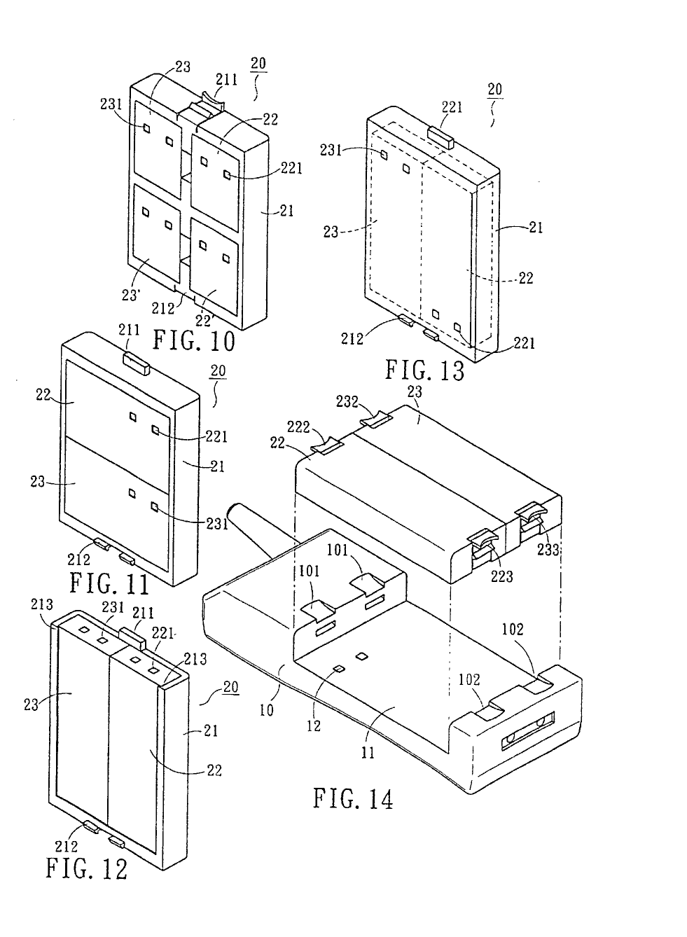

The number of battery housed in the battery assembly is changeable. As shown in the FIG. 10, the casing 21 contains four pieces of batteries, 22, 23, 22′ and 23′. The batteries can be either vertically or horizontally arranged. As shown in the FIG. 11, two batteries 22, 23 are horizontally arranged in the casing 21. The casing 21 can be made a recess either with four side seals or with one end open as shown in the FIG. 12 provided with a crop-up margin 213 to prevent the battery slipping out. In the FIG. 13, the batteries 22 and 23 are in the opposite arrangement housed in the casing 21 of the battery assembly 20, and their metal terminals 221 and 231 are extending outward. The FIG. 14 shows a battery assembly 20 with no casing 21, barely two batteries 22 and 23 hooked up to the cell phone set 10. Under such a circumstance, the cell phone set has two sets of the upper and lower fastening notches 101, 102 which couple with the upper and lower fastening buckles 222, 223, 232, and 233. It is understandable that the battery assembly of the invention varies in great extent.

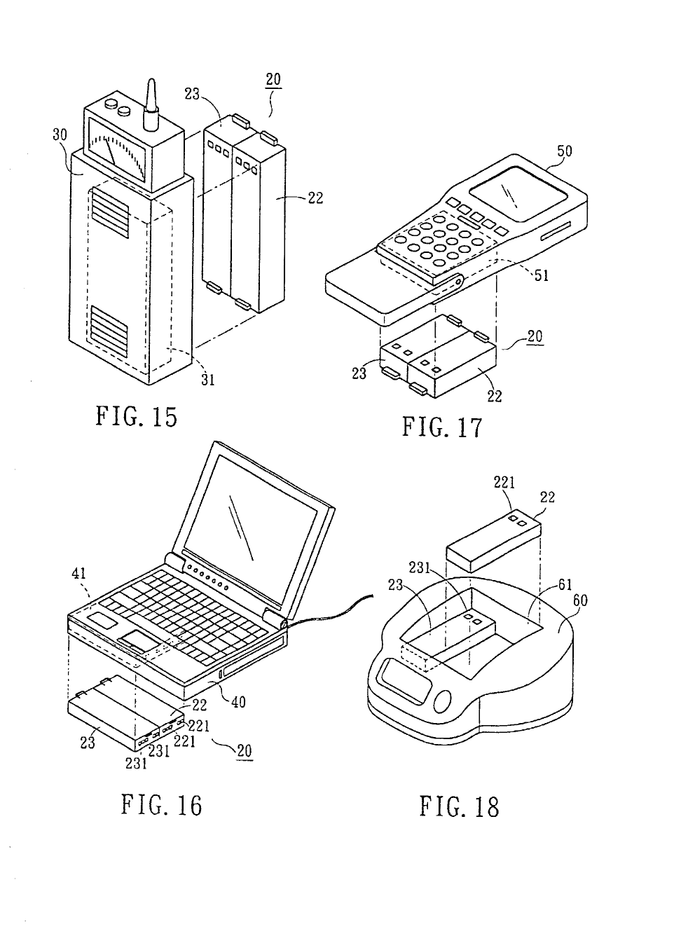

Similarly, the battery assembly is also applicable to other portable electronic product, such as the stereo assembly of the standby battery assembly and the radio walkie-talkie as shown in the FIG. 15 where the battery assembly containing two batteries 22 and 23 is directly inserted into the recess 31 of the radio walkie-talkie 30, or using a casing (not shown) with two batteries 22 and 23 to be inserted in the recess 31 of the radio walkie-talkie.

Similarly, the battery assembly 20 is inserted in the recess 41 of the notebook PC 40 as shown in the FIG. 16, the battery assembly 20 in the recess 51 of the PDA 50 as shown in the FIG. 17, and the battery assembly 20 in the recess 61 of the charger board 60 as shown in the FIG. 18. In short, the battery assembly of the invention is suitable for use on a variety of portable electronic products.

The major achievements the invention has attained are:

(1) When the battery of the portable electronic product runs short of power supply, the standby battery assembly can resume the operation immediately, avoiding communication disruption or power outage.

(2) The battery assembly reminds of the end users to recharge the exhausted battery from time to time and give sufficient buffer time for the end sue to recharge the batter,

(3) The battery assembly is ready for use with the portable electronic product without modification.

(4) The battery assembly is easy to bring with the portable electronic product, solving the emergent need.

(5) The life span of the battery is limited, declining day after day. The battery assembly provides two batteries with varying life spans, at least the worry for power shortage in operating the portable electronic products is therefore alleviated.

What is claimed is:

1. A standby battery assembly for use on the portable electronic products.
When being incorporated with the portable electronic products, it is characterized on that:
The standby battery assembly comprises a casing for housing a plurality of batteries, one of which acts as the main battery with metal contact connecting to the conductive contact of the portable electronic product to supply the power the portable electronic products need. When the main battery runs out of power, the standby battery immediately resume the job to keep the cell phone set in constant operation and provide sufficient buffer time for recharging the exhausted battery.

2. The standby battery assembly for use on the portable electronic products as claimed in the claim (1) in which the battery assembly has a recess type casing with peripheral seal.

3. The standby battery assembly for use on the portable electronic products as claimed in the claim (1) in which the battery assembly has a recess type casing with peripheral seal but an open top.

4. The standby battery assembly for use on the portable electronic products as claimed in the claim (1) in which the battery assembly has a recess type casing with peripheral seal but the metal contacts extend outside the seal.

5. The standby battery assembly for use on the portable electronic products as claimed in the claim (1) in which the battery assembly is provided a selection switch mounted on the back of the casing and a circuit board fixed inside the casing.

6. The standby battery assembly for use on the portable electronic products as claimed in the claim (1) in which the batteries are reversibly arranged in the battery assembly.

7. The standby battery assembly for use on the portable electronic products as claimed in the claim (1) in which the batteries are arranged in the same direction in the battery assembly.

8. The standby battery assembly for use on the portable electronic products as claimed in the claim (1) which is applicable to the cell phone set.

9. The standby battery assembly for use on the portable electronic products as claimed in the claim (1) which is applicable to the radio walkie-talkie.

10. The standby battery assembly for use on the portable electronic products as claimed in the claim (1) which is applicable to the notebook PC.

11. The standby battery assembly for use on the portable electronic products as claimed in the claim (1) which is applicable to the PDA.

12. The standby battery assembly for use on the portable electronic products as claimed in the claim (1) which is applicable to the battery re-charger board.

13. A standby battery assembly for use on the portable electronic products. When being incorporated with the portable electronic products, it is characterized on that:
The standby battery assembly contains a plurality of batteries, held in the recess of the portable electronic products, in which the metal contact of the main battery connects to the conductive contact of the portable electronic product so to supply the power the portable electronic products are in need. When the main battery runs out of power, the standby battery immediately resume the job to keep the cell phone set in constant operation and provide sufficient buffer time for recharging the exhausted battery.
